(19) United States
(12) Patent Application Publication
(10) Pub. No.: US 2022/0392679 A1
(43) Pub. Date: Dec. 8, 2022

(54) SUPERCONDUCTING COIL MODULE

(71) Applicant: Seoul National University R&DB Foundation, Seoul (KR)

(72) Inventors: Seungyong HAHN, Seoul (KR); Soobin AN, Seoul (KR); Kibum CHOI, Yongin-si (KR); Chaemin IM, Seoul (KR); Jeseok BANG, Seoul (KR)

(21) Appl. No.: 17/408,970

(22) Filed: Aug. 23, 2021

(30) Foreign Application Priority Data
May 31, 2021 (KR) 10-2021-0070342

(51) Int. Cl. H01F 6/06; H01F 6/02

(52) U.S. Cl. CPC H01F 6/06; H01F 6/02

(57) ABSTRACT

A superconducting coil module includes: a superconducting coil configured by winding a superconducting wire a plurality of times; and a magnetic dam wound along a shape of the superconducting coil, and electromagnetically coupled. The magnetic dam may include a conductive structure device insulated from the superconducting coil, and implemented by a conductive wire wound along the shape of the superconducting coil a plurality of times, and a control circuit controlling current which flows to the magnetic dam during charging and discharging of the superconducting coil between both terminals of the conductive wire.

### CROSS-REFERENCE TO RELATED APPLICATION

This application claims priority to and the benefit of Korean Patent Application No. 10-2021-0070342 filed in the Korean Intellectual Property Office on May 31, 2021, the entire contents of which are incorporated herein by reference.

### BACKGROUND OF THE INVENTION

### (a) Field of the Invention

The present invention relates to a superconducting coil module. Particularly, the present invention relates to a superconducting coil module constituting a superconducting magnet.

### (b) Description of the Related Art

A superconducting magnet can be operated with an even higher current density than an existing electromagnet. When the superconducting magnet is applied to an electric device, epochal improvement of an energy density and weight reduction are possible. In particular, a high temperature superconducting magnet is one of candidates to lead commercialization of a superconducting electric device due to a relatively high operating temperature and a relatively high operation stability, and a lot of researches into the high temperature superconducting magnet are in progress. However, when a quench phenomenon in which superconductivity suddenly disappears in a superconducting magnetic material occurs, there has been a problem in that a coil of the superconducting magnet is burned.

In order to solve this problem, a no-insulation winding technique is proposed. High temperature superconducting magnets to which this technique is applied can successfully achieve a target magnetic field. Further, even when the quench occurs, current in the coil detours a point where the quench occurs to protect the superconducting magnet.

As such, the high temperature superconducting magnets to which the no-insulation winding technique is applied are not electrically burned when the quench occurs, but under a high magnetic field condition of the superconducting magnet, a phenomenon occurs in which a superconducting wire is mechanically deformed due to current which is induced in the superconducting coil during the quench. When mechanical deformation occurs in the high temperature superconducting wire, a performance of the high temperature superconducting wire is rapidly dropped.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a superconducting coil module capable of preventing mechanical deformation when a quench occurs in a superconducting coil.

An exemplary embodiment of the present invention provides a superconducting coil module including: a superconducting coil configured by winding a superconducting wire a plurality of times; and a magnetic dam wound along a shape of the superconducting coil, and electromagnetically coupled. The magnetic dam may include a conductive structure device insulated from the superconducting coil, and implemented by a conductive wire wound along the shape of the superconducting coil a plurality of times, and a control circuit controlling current which flows to the magnetic dam during charging and discharging of the superconducting coil between both terminals of the conductive wire.

The conductive wire may be wound along an exterior of the superconducting coil a plurality of times. The magnetic dam may further include an insulation device including an insulation member located between the conductive structure device and the superconducting coil.

The superconducting coil module may further include a superconducting coil support body located on an interior of the superconducting coil, and the conductive wire may be wound along an exterior of the superconducting coil support body a plurality of times.

The magnetic dam may further include an insulation device including an insulation wire located between the conductive wires. When the conductive wire is wound along an exterior of the superconducting coil a plurality of times, the insulation wire may include an insulation member located between the superconducting coil and the conductive wire.

The control circuit may include a switching element which is in an off state when the superconducting coil is charged and discharged and in an on state when the superconducting coil is not charged and discharged.

The control circuit may include a diode connected between both terminals of the conductive wire so that a direction of current induced to the magnetic dam becomes an inverse direction when the superconducting coil is charged.

The control circuit may include a capacitor which causes resonance with an inductor component of the magnetic dam with respect to a specific frequency of an electromagnetic wave induced to the magnetic dam when a quench occurs.

Another exemplary embodiment of the present invention provides a superconducting coil module including: a superconducting coil configured by winding a superconducting wire a plurality of times; a conductive structure device including a conductive wire wound on the superconducting coil along an exterior of the superconducting coil a plurality of times; an insulation device including a first insulation member located between the conductive structure device and the superconducting coil; and a control circuit controlling current which flows to the magnetic dam during charging and discharging of the superconducting coil between both terminals of the conductive wire.

The insulation device may further include an insulation wire wound on the superconducting coil together with the conductive wire.

When the conductive wire is separated in units of one turn in the conductive structure device, the conductive structure device may include a plurality of conductive members, when the insulation wire is separated in units of one turn in the insulation device, the insulation device may include a plurality of second insulation members, and one corresponding second insulation member among of the plurality of second insulation members may be located between two adjacent conductive members among the plurality of conductive members.

Yet another exemplary embodiment of the present invention provides a superconducting coil module including: a superconducting coil configured by winding a superconducting wire a plurality of times; a superconducting coil support body located on an interior of the superconducting coil; a conductive structure device including a conductive wire wound on the superconducting coil along an interior of the superconducting coil support body a plurality of times; and a control circuit controlling current which flows to the magnetic dam during charging and discharging of the superconducting coil between both terminals of the conductive wire.

The superconducting coil module may further include an insulation device including an insulation wire wound on the superconducting coil together with the conductive wire.

When the conductive wire is separated in units of one turn in the conductive structure device, the conductive structure device may include a plurality of conductive members, when the insulation wire is separated in units of one turn in the insulation device, the insulation device may include a plurality of insulation members, and one corresponding second insulation member among of the plurality of insulation members may be located between two adjacent conductive members among the plurality of conductive members.

The at least one superconducting coil may include two adjacent superconducting coils, and the magnetic dam may be located between the two adjacent superconducting coils. The at least one superconducting coil may include two adjacent superconducting coils, and the magnetic dam may be located between the two adjacent superconducting coils.

The magnetic dam may further include a control circuit controlling current which flows to the magnetic dam during charging and discharging of the superconducting coil between both terminals of the conductive wire.

The conductive structure device may include a conductive wire wound along shapes of the two adjacent superconducting coils between the two adjacent superconducting coils, and the magnetic dam may further include an insulation device including an insulation wire wound along the shape of the superconducting coil together with the conductive wire.

The conductive wire of the conductive structure device may be a high temperature superconductor.

According to an exemplary embodiment of the present invention, provided is a superconducting coil module capable of preventing mechanical deformation when a quench occurs in a superconducting coil.

### BRIEF DESCRIPTION OF THE DRAWINGS

FIG. 1 is a diagram illustrating a magnetic dam according to an exemplary embodiment of the present invention.

FIG. 2 is an exploded view of the magnetic dam of FIG. 1.

FIG. 3 is a diagram illustrating a magnetic dam according to an exemplary embodiment.

FIG. 4 is an exploded view of the magnetic dam of FIG. 3.

FIG. 5 is a diagram schematically illustrating a control circuit located between both terminals of a magnetic dam according to an exemplary embodiment.

FIG. 6 is a diagram illustrating a superconducting coil module in which a magnetic dam is applied to an exterior of a superconducting coil according to an exemplary embodiment.

FIG. 7 is a diagram illustrating a superconducting coil module in which a magnetic dam is applied to an interior of a superconducting coil according to an exemplary embodiment.

FIG. 8 is a diagram illustrating a superconducting coil module in which a magnetic dam is applied to a superconducting coil according to an exemplary embodiment.

FIG. 9 is an exploded view of the superconducting coil module illustrated in FIG. 8.

FIG. 10 is a diagram illustrating a racetrack type superconducting coil module according to an exemplary embodiment.

FIG. 11 is a diagram illustrating a saddle type superconducting coil module according to an exemplary embodiment.

FIG. 12 is an exploded view of the superconducting coil module of FIG. 11.

FIG. 13 is a diagram illustrating a toroidal type superconducting coil module according to an exemplary embodiment.

FIG. 14 illustrates an equivalent circuit for a superconducting coil module including a passive magnetic dam according to an exemplary embodiment.

FIG. 15 illustrates an equivalent circuit for a superconducting coil module including an active magnetic dam according to an exemplary embodiment.

FIG. 16 is a graph showing a current, a voltage, and a magnetic field of a superconducting coil module when the superconducting coil module is charged and discharged when there is no control device in a magnetic dam.

FIG. 17 is a graph showing a current, a voltage, and a magnetic field of a superconducting coil module when the superconducting coil module is charged and discharged when the magnetic dam includes the control device.

FIG. 18 illustrates a quench simulation result for a superconducting coil module according to an exemplary embodiment.

FIG. 19 is a diagram illustrating a superconducting coil module according to an exemplary embodiment.

FIG. 20 is a graph showing a simulation result for a voltage, a temperature, and a current of each of a plurality of superconducting coils when a quench occurs in a condition that there is no magnetic dam in the superconducting coil module of FIG. 19.

FIG. 21 is a graph showing a simulation result for a voltage, a temperature, and a current of each of a plurality of superconducting coils when the quench occurs in the superconducting coil module of FIG. 19.

FIG. 22 is a graph showing an accumulation amount of an inducted current density and consumed energy of the magnetic dam when the quench occurs in the superconducting coil module of FIG. 19.

FIG. 23 is a graph showing a simulation result for a voltage, a temperature, and a current of each of a plurality of superconducting coils when the quench occurs in the superconducting coil module of FIG. 19, which includes a magnetic dam manufactured by a high temperature superconductor.

FIG. 24 is a graph showing an accumulation amount of an inducted current density and consumed energy of the magnetic dam when the quench occurs in magnetic dam manufactured by a high temperature superconductor.

FIG. 25 is a perspective view of a superconducting coil module according to an exemplary embodiment.

FIG. 26 is a diagram schematically illustrating a cross section of the superconducting coil module illustrated in FIG. 25.

FIG. 27 is a graph showing a quench simulation result for the superconducting coil module according to an exemplary embodiment of FIG. 25.

### DETAILED DESCRIPTION OF THE EMBODIMENTS

In order to apply a high magnetic field superconducting electromagnet to an electric device, the present invention relates to a magnetic damper structure for protecting a superconducting coil during a quench. Hereinafter, a structure for protecting the superconducting coil will be referred to as a magnetic dam. The magnetic dam may be electromagnetically coupled to the superconducting coil. Further, in addition to electromagnetic coupling, the magnetic dam may be implemented as a conductive structure device physically coupled to the superconducting coil. The magnetic dam may prevent deformation of a coil by reducing current induced to the superconducting coil electromagnetically connected to a superconducting coil in which the quench occurs when the quench occurs in the superconducting coil. That is, the magnetic dam may delay a quench propagation of the superconducting coil, absorb energy depending on induction current by the quench, and prevent mechanical deformation of the superconducting coil by the quench. A superconducting electromagnet in the present invention may be widely applied to various electric devices including NMR, MRI, and the like.

In the present invention, the magnetic dam may be applied to a non-insulation type superconducting coil. The no-insulation type includes no-insulation, partial insulation, and metal insulation.

In the present invention, a material of the magnetic dam may be one of copper, a low temperature superconductor, and a high temperature superconductor.

In the present invention, an insulation type of the magnetic dam may be any one of insulation, the no-insulation, the partial insulation, and the metal insulation.

In the present invention, the magnetic dam may be located in at least one of an inside and an outside of the superconducting coil. Alternatively, the magnetic dam may be located between at least two coils in a superconducting electromagnet in which at least two coils are stacked.

In the present invention, the magnetic dam may be an active type in which an operation is controlled through a switch or a passive type without the switch.

Hereinafter, exemplary embodiments of the present invention will be described with reference to the accompanying drawings. Prior to this, terms and words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. Accordingly, configurations illustrated in the exemplary embodiments and drawings disclosed in the present specification are only an exemplary embodiment of the present invention and do not represent all of the technical spirit of the present invention, and thus it is to be understood that various equivalents and modified examples, which may replace the configurations, are possible at the time of the present invention.

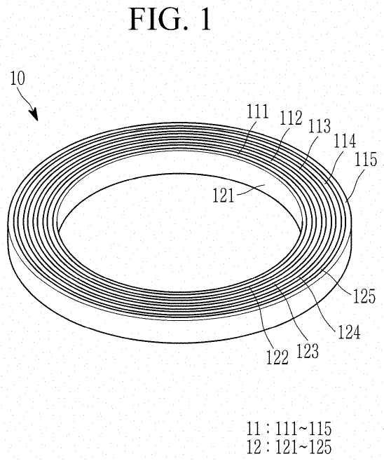

FIG. 1 is a diagram illustrating a magnetic dam according to an exemplary embodiment.

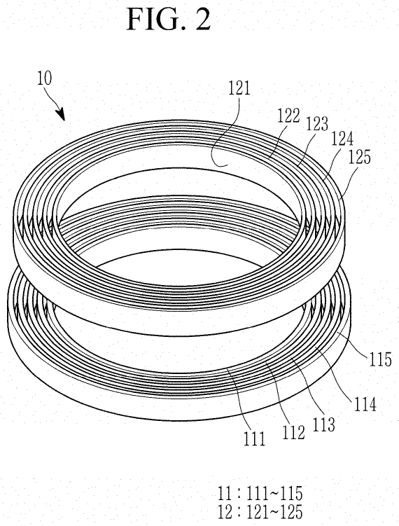

FIG. 2 is an exploded view of the magnetic dam of FIG. 1.

The magnetic dam illustrated in FIGS. 1 and 2 is illustrated in a shape applied to a solenoid type superconducting coil. However, the present invention is not limited thereto, and the shape of the magnetic dam may be changed according to various types of superconducting coil shapes.

A magnetic dam 10 includes a conductive structure device 11 and an insulation device 12. The conductive structure device 11 may be implemented in which a conductive wire is wound in a circular shape which is a shape according to a solenoid type superconducting coil. In this case, an insulation wire is together wound on the superconducting coil according to a conductive wire to implement the insulation device 12.

For convenience of description, the conductive wire and the insulation wire are described separately in units of one turn. When the conductive wire is separated in units of one turn in the conductive structure device 11, the conductive structure device 11 includes a plurality of conductive members 111 to 115. When the insulation wire is separated in units of one turn in the insulation device 12, the insulation device 12 includes a plurality of insulation members 121 to 125.

In FIG. 2, the conductive structure device 11 and the insulation device 12 are separated and illustrated. As illustrated in FIG. 2, the plurality of insulation members 122 to 125 are located between the plurality of conductive members 111 to 115, and as a result, the plurality of conductive members 111 to 115 are insulated from each other. The insulation member 121 is located on an interior of the conductive member 111, and as a result, the superconducting coil and the conductive structure device 11 are insulated from each other. That is, the insulation member (e.g., reference numeral 122) may be located between two adjacent conductive members (e.g., reference numerals 111 and 112) among the plurality of conductive members 111 to 115, and the insulation member 121 may be located between the superconducting coil and the conductive member 111.

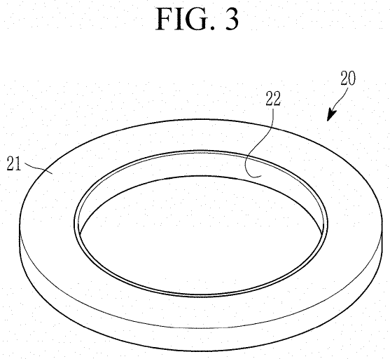

FIG. 3 is a diagram illustrating a magnetic dam according to an exemplary embodiment.

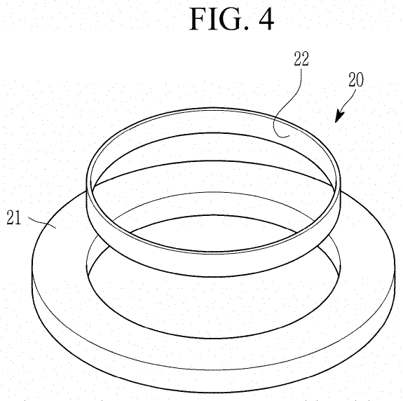

FIG. 4 is an exploded view of the magnetic dam of FIG. 3.

The magnetic dam 20 illustrated in FIGS. 3 and 4 is illustrated in a shape applied to the solenoid type superconducting coil. However, the present invention is not limited thereto, and the shape of the magnetic dam may be changed according to various types of superconducting coil shapes. The magnetic dam illustrated in FIGS. 1 and 2 is an insulation type, and as illustrated in FIGS. 1 and 2, the insulation member is coupled between the conductive members. However, the magnetic dam illustrated in FIGS. 3 and 4 is a non-insulation type, and the insulation member is not present between the conductive members.

As illustrated in FIGS. 3 and 4, the magnetic dam 20 includes a magnetic conductive structure device 21 and an insulation device 22. The conductive structure device 21 may be implemented in which a conductive wire is wound in a circular shape which is a shape according to a solenoid type superconducting coil. The conductive wire may be made of copper, a low temperature superconductor, or a high temperature superconductor. The insulation wire is wound along an interior surface of the conductive structure device 21 to implement the insulation device 22.

When the magnetic dam is a passive type, both terminals (hereinafter, referred to as both terminals of the magnetic dam) of the conductive wire of an insulation type magnetic dam may be shorted. Even in the case of a no-insulation type magnetic dam, both terminals of the magnetic dam may be shorted. In particular, when the material of the conductive wire is the low temperature superconductor, the high temperature superconductor, etc., resistance of the magnetic dam may not be small. Even in the case of the no-insulation type magnetic dam, both terminals of the magnetic dam may be shorted in order to reduce the resistance.

When the magnetic dam is the active type, a control circuit is connected between both terminals of the insulation type and the no-insulation type magnetic dams. The control circuit may be implemented as at least one of a diode, a capacitor, and a switch. In charging and discharging the superconducting coil, in order to reduce an influence which the magnetic dam exerts to the charging and the discharging, the control circuit operates to control the current of the magnetic dam during the charging and the discharging.

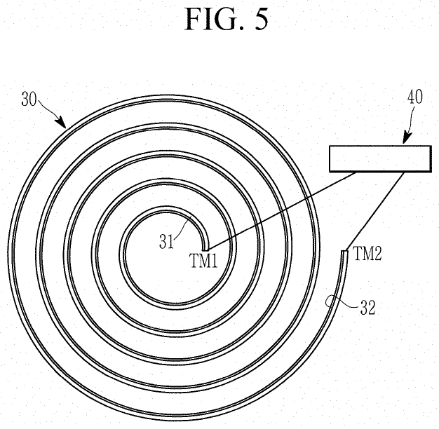

FIG. 5 is a diagram schematically illustrating a control circuit located between both terminals of a magnetic dam according to an exemplary embodiment.

As illustrated in FIG. 5, a control circuit 40 is connected between both terminals TM1 and TM2 of the magnetic dam 30. In FIG. 5, the insulation type magnetic dam 30 implemented by the conductive wire 31 and the conductive insulation wire 32 is illustrated. In FIG. 5, it is illustrated that the conductive insulation wire 32 is located on one side (on an exterior of the conductive wire in FIG. 5) of the conductive wire 31, but the present invention is not limited thereto. The conductive insulation wire 32 may be located on the other side (an exterior of the conductive wire in FIG. 5) or both sides of the conductive wire 31. A connection relationship between the magnetic dam and the control circuit illustrated in FIG. 5 may be equally applied even to the no-insulation type magnetic dam.

When the control circuit 40 is implemented by a switching element, the switching element is in an off state when charging and discharging the superconducting coil. During a period in which the switching element is in the off state, the magnetic dam 30 does not operate. When the superconducting coil is not charged and discharged, the switching element is turned on so as to prepare for an emergency situation such as the quench.

When the control circuit 40 is implemented as the diode, the control circuit 40 controls current to flow on the magnetic dam 30 in a forward direction of the diode. When the quench occurs in the superconducting coil, the current of the superconducting coil is rapidly generated in a discharge direction. That is, in the magnetic dam 30, the diode is connected between both terminals TM1 and TM2 so that a direction of current induced to the magnetic dam 30 becomes an inverse direction with respect to the diode when the superconducting coil is charged. For example, in a condition in which the both terminals TM1 and TM2 are shorted (there is no control circuit), if current which flows from a terminal TM1 to a terminal TM2 is induced when charging the superconducting coil, the diode of the control circuit 40 is connected to both terminals TM1 and TM2 so that a TM1->TM2 current direction becomes the inverse direction. That is, an anode of the diode may be connected to the terminal TM2 and a cathode of the diode may be connected to the terminal TM1. That is, the diode is connected to both terminals TM1 and TM2 so that the forward direction of the diode is opposite to the direction of the current induced to the magnetic dam when charging the superconducting coil. Since the current flows in the discharge direction of the superconducting coil when the quench occurs, the direction of the current which flows on the magnetic dam 30 matches the forward direction of the diode.

When the control circuit 40 is implemented as the capacitor, the capacitor may be designed so as to cause resonance with an inductor component of the magnetic dam 30 with respect to a specific frequency of an electromagnetic wave induced to the magnetic dam 30 when the quench occurs. Through resonance in a specific frequency band when the quench occurs, the resistance of the magnetic dam 30 is very small. Since the quench generally occurs even more rapidly than charging and discharging operations of the superconducting coil, an electromagnetic wave having a higher frequency band than the electromagnetic wave when the superconducting coil is charged and discharged is induced to the magnetic dam 30. In this case, the capacitor of the control circuit 40 resonates by matching the inductor component of the magnetic dam 30 in a specific frequency band during the quench.

Hereinafter, various exemplary embodiments in which the superconducting coil and the magnetic dam are coupled will be described with reference to drawings.

The type of superconducting coil may be implemented as a solenoid type, a race track type, a saddle type, a toroidal type, etc., and the present invention may be applied to all types of superconducting coils. First, exemplary embodiments in which the magnetic dam is coupled to the solenoid type superconducting coil will be described.

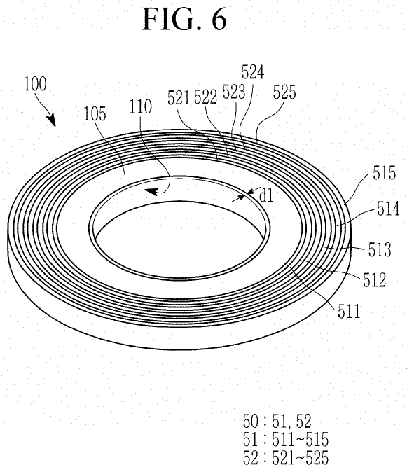

FIG. 6 is a diagram illustrating a superconducting coil module in which a magnetic dam is applied to an exterior of a superconducting coil according to an exemplary embodiment.

In FIG. 6, a superconducting coil module 100 includes a pancake structure superconducting coil 105 among various structures of coils. As illustrated in FIG. 6, a central region of a superconducting coil 10 may be a shape in which a superconducting wire is not wound. However, the present invention is not limited thereto, and various types of superconducting coils may be used. The superconducting coil module 100 includes a superconducting coil 105, a structure (hereinafter, referred to as a superconducting coil support body) 110 for supporting the superconducting coil, and a magnetic dam 50.

The superconducting coil 105 may be implemented by winding the superconducting wire in the no-insulation type in a solenoid shape. The superconducting coil support body 110 as a ring type including an exterior which is in contact with the interior of the superconducting coil 105 may be located on the interior of the superconducting coil 105. A width d1 of the superconducting coil support body 110 may be appropriately set according to a support force required for the superconducting coil support body 110.

The magnetic dam 50 which has a shape to surround the exterior of the superconducting coil 105 may be electromagnetically coupled to the superconducting coil 105. In FIG. 6, the magnetic dam 50 is illustrated as the insulation type, but the no-insulation type magnetic dam may be electromagnetically coupled to the superconducting coil 105 similarly in a scheme illustrated in FIG. 6.

The magnetic dam 50 includes a conductive structure device 51 and an insulation device 52. When the conductive structure device 51 is separated in units of one turn, the conductive structure device 51 includes a plurality of conductive members 511 to 515. When the insulation device 52 is separated in units of one turn, the insulation device 52 includes a plurality of insulation members 521 to 525. For insulation among the plurality of conductive members 511 to 515 and insulation between the superconducting coil 105 and the conductive structure device 51, the plurality of insulation members 521 to 525 may be located. That is, the insulation member (e.g., reference numeral 522) is located between two adjacent conductive members (e.g., reference numerals 511 and 512) among the plurality of conductive members 511 to 515, and the insulation member 521 is located between the superconducting coil 105 and the conductive member 511.

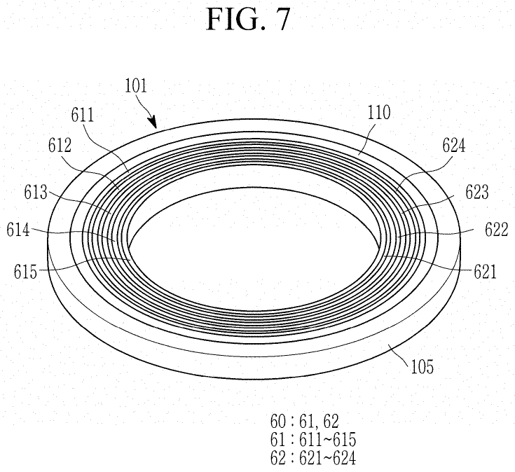

FIG. 7 is a diagram illustrating a superconducting coil module in which a magnetic dam is applied to an interior of a superconducting coil according to an exemplary embodiment.

The superconducting coil module 101 includes a superconducting coil 105, a superconducting coil support body 110, and a magnetic dam 60.

In the exemplary embodiment of FIG. 7, the exterior of the magnetic dam 60 may be electromagnetically coupled to the superconducting coil 105 while contacting the interior of the superconducting coil support body 110 unlike the exemplary embodiment of FIG. 6. In FIG. 7, the magnetic dam 60 is illustrated as the insulation type, but the no-insulation type magnetic dam may be electromagnetically coupled to the superconducting coil 105 similarly in a scheme illustrated in FIG. 7.

The magnetic dam 60 includes a conductive structure device 61 and an insulation device 62. When the conductive structure device 61 is separated in units of one turn, the conductive structure device 61 includes a plurality of conductive members 611 to 615. When the insulation device 62 is separated in units of one turn, the insulation device 62 includes a plurality of insulation members 621 to 624. For insulation among the plurality of conductive members 611 to 615, the plurality of insulation members 621 to 624 may be located. That is, the insulation member (e.g., reference numeral 621) is located between two adjacent conductive members (e.g., reference numerals 611 and 612) among the plurality of conductive members 611 to 615. When the magnetic dam 60 is coupled to the interior of the superconducting coil module 101, the superconducting coil support body 110 is located between the superconducting coil 105 and the conductive member 615, and as a result, the insulation member may not be located.

In FIGS. 6 and 7, it is illustrated that the superconducting coil modules 100 and 101 have a single plate structure, but the present invention is not limited thereto. The superconducting coil module may be implemented in a structure in which a plurality of superconducting coil layers are stacked. In this case, the magnetic dam may be located between the superconducting coil layer and the superconducting coil layer.

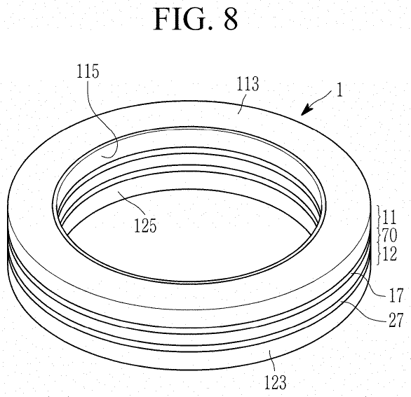

FIG. 8 is a diagram illustrating a superconducting coil module in which a magnetic dam is applied to a superconducting coil according to an exemplary embodiment.

As illustrated in FIG. 8, the superconducting coil module 1 includes two stacked superconducting coil layers 11 and 12, a magnetic dam 70, and two insulation layers 17 and 27. As illustrated in FIG. 8, a structure in which two superconducting coil layers are stacked is referred to as a double pancake structure. For reference, one superconducting coil layer is referred to as a single pancake structure.

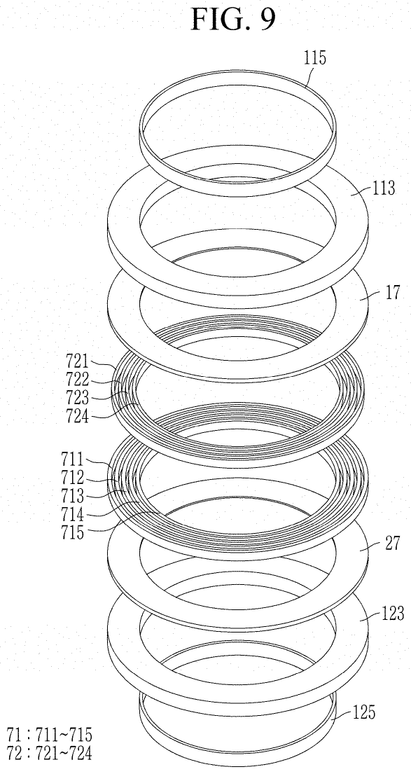

A stacking structure of FIG. 8 is described with reference to FIG. 9.

FIG. 9 is an exploded view of the superconducting coil module illustrated in FIG. 8.

The superconducting coil layer 11 includes a superconducting coil support body 115 and a superconducting coil 113, and the superconducting coil support body 115 as a ring type including an exterior contacting an interior of the superconducting coil 113 is located on the interior of the superconducting coil 113. The superconducting coil layer 12 includes a superconducting coil support body 125 and a superconducting coil 123, and the superconducting coil support body 125 as a ring type including an exterior contacting an interior of the superconducting coil 123 is located on the interior of the superconducting coil 123.

An insulation layer 17 for insulation between the superconducting coil layer 11 and the magnetic dam 70 is located between the superconducting coil layer 11 and the magnetic dam 70. An insulation layer 27 for insulation between the superconducting coil layer 12 and the magnetic dam 70 is located between the superconducting coil layer 12 and the magnetic dam 70. The magnetic dam 70 is electromagnetically coupled to two superconducting coil layers 11 and 12.

The magnetic dam 70 includes a conductive structure device 71 and an insulation device 72. In FIG. 9, the magnetic dam 70 is illustrated as the insulation type, but the no-insulation type magnetic dam may be electromagnetically coupled to two superconducting coil layers 11 and 12 similarly in a scheme illustrated in FIG. 9.

The magnetic dam 70 includes a conductive structure device 71 and an insulation device 72. When the conductive structure device 71 is separated in units of one turn, the conductive structure device 71 includes a plurality of conductive members 711 to 715. When the insulation device 72 is separated in units of one turn, the insulation device 72 includes a plurality of insulation members 721 to 724. For insulation among the plurality of conductive members 711 to 715, the plurality of insulation members 721 to 724 may be located. That is, the insulation member (e.g., reference numeral 721) is located between two adjacent conductive members (e.g., reference numerals 711 and 712) among the plurality of conductive members 711 to 715.

A shape of the magnetic dam may be changed depending on a shape of the superconducting coil to which the magnetic dam is electromagnetically coupled.

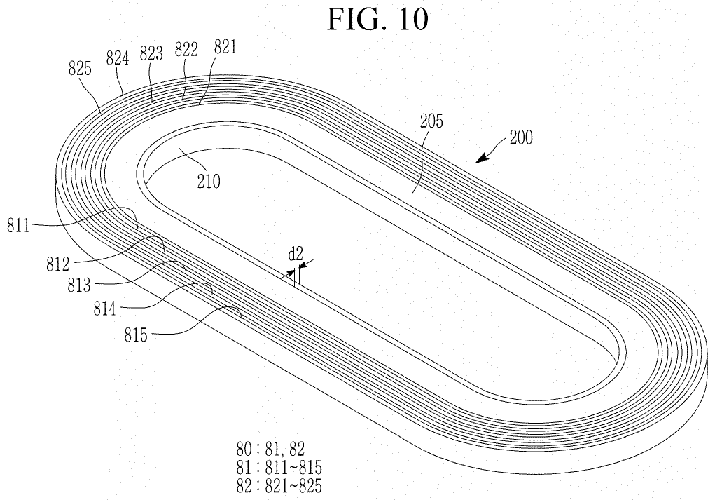

FIG. 10 is a diagram illustrating a racetrack type superconducting coil module according to an exemplary embodiment.

As illustrated in FIG. 10, a superconducting coil module 200 includes a superconducting coil 205, a superconducting coil support body 210, and a magnetic dam 80. The superconducting coil 205 may be implemented by winding the superconducting wire in the no-insulation type in a racetrack shape. The superconducting coil support body 210 as a racetrack type including an exterior which is in contact with the interior of the superconducting coil 205 may be located on the interior of the superconducting coil 205. A width d2 of the superconducting coil support body 210 may be appropriately set according to a support force required for the superconducting coil support body 210.

The magnetic dam 80 which has a shape to surround the exterior of the superconducting coil 205 may be electromagnetically coupled to the superconducting coil 205. In FIG. 10, the magnetic dam 80 is illustrated as the insulation type, but the no-insulation type magnetic dam may be electromagnetically coupled to the superconducting coil 205 similarly in a scheme illustrated in FIG. 10.

The magnetic dam 80 includes a conductive structure device 81 and an insulation device 82. When the conductive structure device 81 is separated in units of one turn, the conductive structure device 81 includes a plurality of conductive members 811 to 815. When the insulation device 82 is separated in units of one turn, the insulation device 82 includes a plurality of insulation members 821 to 825. For insulation among the plurality of conductive members 811 to 815 and insulation between the superconducting coil 205 and the conductive structure device 81, the plurality of insulation members 821 to 825 may be located. That is, an insulation member (e.g., reference numeral 822) is located between two adjacent conductive members (e.g., reference numerals 811 and 812) among the plurality of conductive members 811 to 815, and an insulation member 821 is located between the superconducting coil 205 and the conductive member 811.

In FIG. 10, it is illustrated that the magnetic dam 80 is located on the exterior of the superconducting coil 205, but the present invention is not limited thereto. The magnetic dam may be located on the interior of the superconducting coil support body 210. Referring to the exemplary embodiment of FIG. 7 related to the solenoid type superconducting coil, it may be construed that the magnetic dam is located on the interior of the superconducting coil support body 210 in the racetrack type superconducting coil module 200.

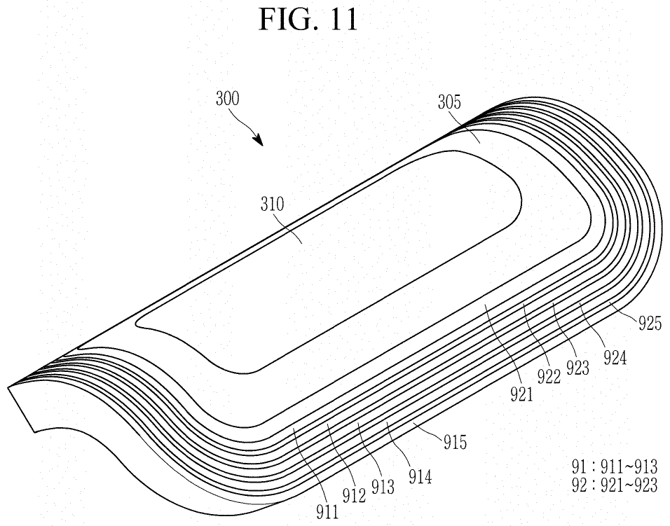

FIG. 11 is a diagram illustrating a saddle type superconducting coil module according to an exemplary embodiment.

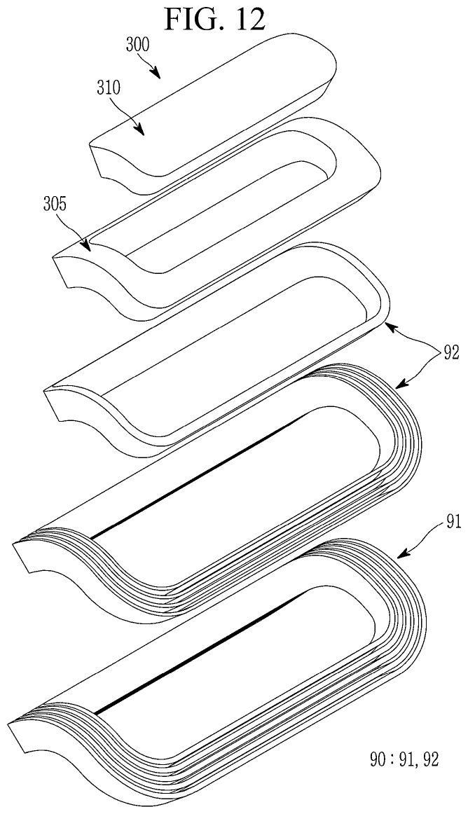

FIG. 12 is an exploded view of the superconducting coil module of FIG. 11.

In order to help understand a coupling structure illustrated in FIG. 11, FIG. 12 is an exploded view of a superconducting coil module 300.

As illustrated in FIGS. 11 and 12, a superconducting coil module 300 includes a superconducting coil 305, a superconducting coil support body 310, and a magnetic dam 90. The superconducting coil 305 may be implemented by winding the superconducting wire in the no-insulation type in a saddle shape. The superconducting coil support body 310 may be located on the interior of the saddle type superconducting coil 305. In FIGS. 11 and 12, the superconducting coil support body 310 is illustrated in a type to fully fill the interior of the superconducting coil 305, but the present invention is not limited thereto. Similarly to the above exemplary embodiment, a predetermined region may be empty based on a center of the superconducting coil support body 310.

The magnetic dam 90 which has a shape to surround the exterior of the superconducting coil 305 may be electromagnetically coupled to the superconducting coil 305. In FIGS. 11 and 12, the magnetic dam 90 is illustrated as the insulation type, but the no-insulation type magnetic dam may be electromagnetically coupled to the superconducting coil 305 similarly in a scheme illustrated in FIGS. 11 and 12.

The magnetic dam 90 includes a conductive structure device 91 and an insulation device 92. When the conductive structure device 91 is separated in units of one turn, the conductive structure device 91 includes a plurality of conductive members 911 to 915. When the insulation device 92 is separated in units of one turn, the insulation device 92 includes a plurality of insulation members 921 to 925. The insulation member 921 is located between the conductive structure device 91 and the superconducting coil 305 for insulation between the conductive structure device 91 and the superconducting coil 305, and the plurality of insulation members 921 to 924 are located between two adjacent conductive members which correspond to each other for insulation among the plurality of conductive members 911 to 915. For example, the insulation members 922 is located between two adjacent conductive members 911 and 912 among the plurality of conductive members 911 to 915.

In FIGS. 11 and 12, it is illustrated that the magnetic dam 90 is located on the exterior of the superconducting coil 305, but the present invention is not limited thereto. The magnetic dam may be located on the interior of the superconducting coil support body 310. When the magnetic dam is located on the interior of the superconducting coil 305, the superconducting coil support body may be formed in a shape in which the center of the superconducting coil support body 310 is empty as large as a size of the magnetic dam. Referring to the exemplary embodiment of FIG. 7 related to the solenoid type superconducting coil, it may be construed that the magnetic dam is located on the interior of the superconducting coil support body 310 in the saddle type superconducting coil module 300.

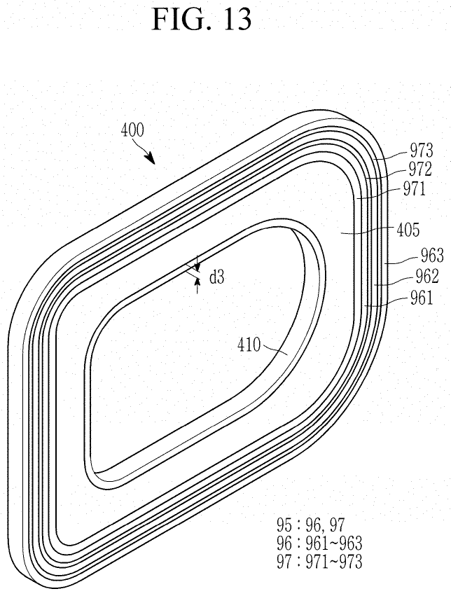

FIG. 13 is a diagram illustrating a toroidal type superconducting coil module according to an exemplary embodiment.

As illustrated in FIG. 13, a superconducting coil module 400 includes a superconducting coil 405, a superconducting coil support body 410, and a magnetic dam 95. The superconducting coil 405 may be implemented by winding the superconducting wire in the no-insulation type in a “D” shape. The superconducting coil support body 410 as a “D” type may be located on the interior of the superconducting coil 405. A width d3 of the superconducting coil support body 410 may be appropriately set according to a support force required for the superconducting coil support body 410.

A magnetic dam 95 which has a shape to surround the exterior of the superconducting coil 405 may be electromagnetically coupled to the superconducting coil 405. In FIG. 13, the magnetic dam 95 is illustrated as the insulation type, but the no-insulation type magnetic dam may be electromagnetically coupled to the superconducting coil 405 similarly in a scheme illustrated in FIG. 13.

The magnetic dam 95 includes a conductive structure device 96 and an insulation device 97. When the conductive structure device 96 is separated in units of one turn, the conductive structure device 96 includes a plurality of conductive members 961 to 963. When the insulation device 97 is separated in units of one turn, the insulation device 97 includes a plurality of insulation members 971 to 973. The insulation member 971 is located between the conductive structure device 96 and the superconducting coil 405 for insulation between the conductive structure device 96 and the superconducting coil 405, and the plurality of insulation members 972 and 973 are located between two adjacent conductive members which correspond to each other for insulation among the plurality of conductive members 961 to 963. For example, the insulation members 972 is located between two adjacent conductive members 961 and 962 among the plurality of conductive members 961 to 963.

In FIG. 13, it is illustrated that the magnetic dam 95 is located on the exterior of the superconducting coil 405, but the present invention is not limited thereto. The magnetic dam may be located on the interior of the superconducting coil support body 410. Referring to the exemplary embodiment of FIG. 7 related to the solenoid type superconducting coil, it may be construed that the magnetic dam is located on the interior of the superconducting coil support body 410 in the toroidal type superconducting coil module 400.

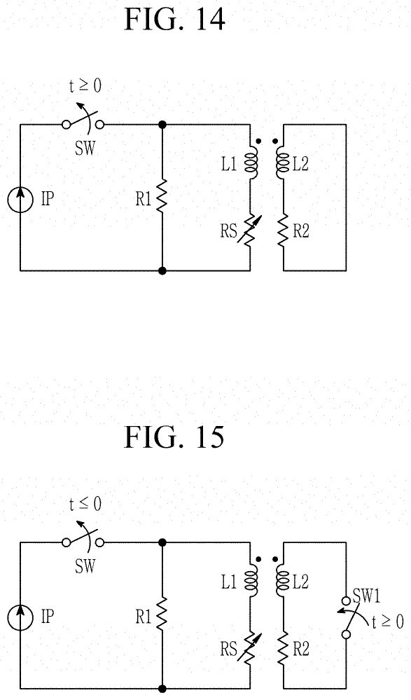

FIG. 14 illustrates an equivalent circuit for a superconducting coil module including a passive magnetic dam according to an exemplary embodiment.

As illustrated in FIG. 14, the superconducting coil may be represented by inductance L1, superconductor resistance RS, and contact resistance R1. The magnetic dam may be represented by inductance L2 and resistance R2. A resistance value of the superconductor resistance RS may vary depending on current which flows on the superconducting wire, i.e., current which flows to the inductance L1. A switch SW is connected between an operating current IP and the superconducting coil. When the switch SW is turned on, the operating current IP flows on the superconducting coil. When the superconducting coil is charged, the operating current IP flows to the superconducting coil and when the superconducting coil is discharged, the operating current IP flows from the superconducting coil.

The magnetic dam is electromagnetically coupled to the superconducting coil, so a rapid current change by the quench induces the current to the inductance L2. Therefore, energy of the superconducting coil is absorbed by the magnetic dam. Therefore, a voltage rise and a peak voltage of another superconducting coil adjacent to the superconducting coil in which the quench occurs may be lowered. Accordingly, according to the present invention, generation of overcurrent and overvoltage by the quench of the superconducting coil may be prevented.

FIG. 15 illustrates an equivalent circuit for a superconducting coil module including an active magnetic dam according to an exemplary embodiment.

A description of the same configuration as the equivalent circuit of FIG. 14 will be skipped. When the magnetic dam is electromagnetically coupled at the time of charging and discharging the superconducting coil, charging and discharging operations of the superconducting coil may be affected.

Therefore, as illustrated in FIG. 15, a switch SW1 is connected between both terminals of the inductor L2. During the charging and discharging operations of the superconducting coil, the switch SW1 is in an off state and when the charging and discharging operations are not performed, the switch SW1 is in an on state. During a period in which the switch SW1 is turned off, the current does not flow on the magnetic dam, and as a result, the magnetic dam does not affect the charging and discharging operations of the superconducting coil.

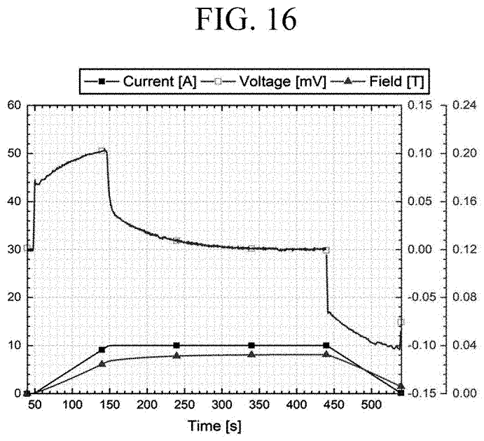

FIG. 16 is a graph showing a current, a voltage, and a magnetic field of a superconducting coil module when the superconducting coil module is charged and discharged when there is no control device in a magnetic dam.

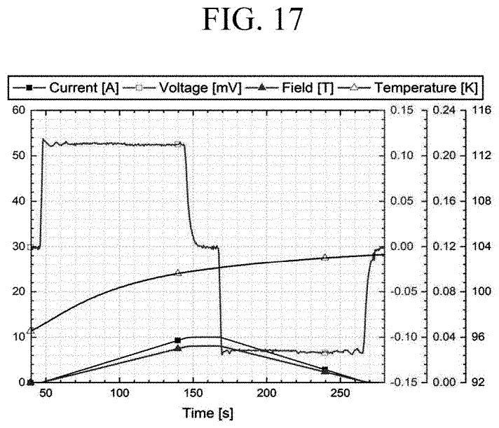

FIG. 17 is a graph showing a current, a voltage, and a magnetic field of a superconducting coil module when the superconducting coil module is charged and discharged when the magnetic dam includes the control device.

In FIG. 17, the control device may be a switching element implemented by high temperature superconducting. A temperature curve of FIG. 17 is a temperature of the switching element, and since the high temperature super conducting loses conductivity at approximately 90 degrees or more, the switching element is in the off state and the magnetic dam in an open state. The magnetic dam which is in the open state is not involved in charging and discharging the superconducting coil module.

During a charging period of 50 to 150 seconds illustrated in FIG. 16, approximately 100 seconds are required for the voltage of the superconducting coil module to reach a highest peak. Unlike this, the voltage of the superconducting coil module illustrated in FIG. 17 reaches the highest peak at a charging start time.

Further, during a discharging period of 440 to 550 seconds illustrated in FIG. 16, approximately 100 seconds are required for the voltage of the superconducting coil module to reach a lowest peak. Unlike this, the voltage of the superconducting coil module illustrated in FIG. 17 reaches the lowest peak at a discharging start time.

As such, when the magnetic dam is continuously shorted, the superconducting coil module may influence charging and discharging. In an exemplary embodiment, the control device is added to minimize the influence on the charging and the discharging of the superconducting coil module.

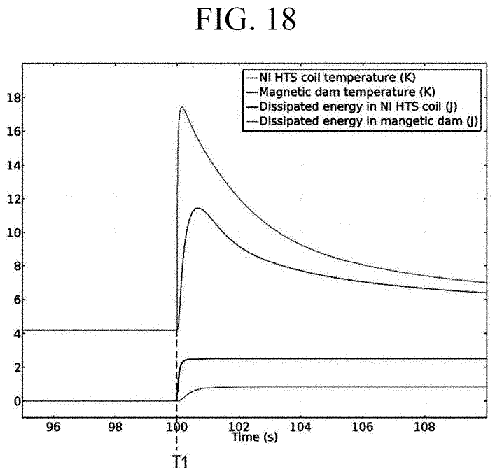

FIG. 18 illustrates a quench simulation result for a superconducting coil module according to an exemplary embodiment.

A simulation is performed under the following condition.

The superconducting coil is a no-insulation high temperature superconductor, the number of turns of the superconducting wire is 100, an inner diameter is 20 mm, an outer diameter is 32 mm, and an experimental temperature is LHe 4.2 K.

The magnetic dam is made of copper (Cu), and a residual-resistivity ratio (RRR) of copper is 100, the inner diameter is 33 mm, and the outer diameter is 38 mm.

As illustrated in FIG. 18, when the quench occurs at a time T1, 0.84 [J] of energy 3.37 [J] stored in the superconducting coil is delivered to the magnetic dam, and consumed, and the remaining energy is consumed in the superconducting coil. When the quench occurs, a temperature peak of the superconducting coil is approximately 17 K and a peak temperature of the magnetic dam is 11.4 K.

In a superconducting coil without the magnetic dam in the related art, since all stored energy is dissipated in the superconducting coil, an energy consumed in the superconducting coil by the quench and a temperature are higher than the present invention.

In order to satisfy an intensity of a magnetic field required for the superconducting coil module, the superconducting coil module may be implemented by stacking a plurality of superconducting coils. When the quench occurs in a specific coil among the plurality of stacked superconducting coils, a phenomenon in which the voltage, the current, and the temperature are raised for a short time occurs even another adjacent coil. When the magnetic dam is electromagnetically coupled to the superconducting coil module, such a phenomenon may be reduced. An exemplary embodiment of the present invention may include a magnetic dam applied to the plurality of stacked superconducting coils.

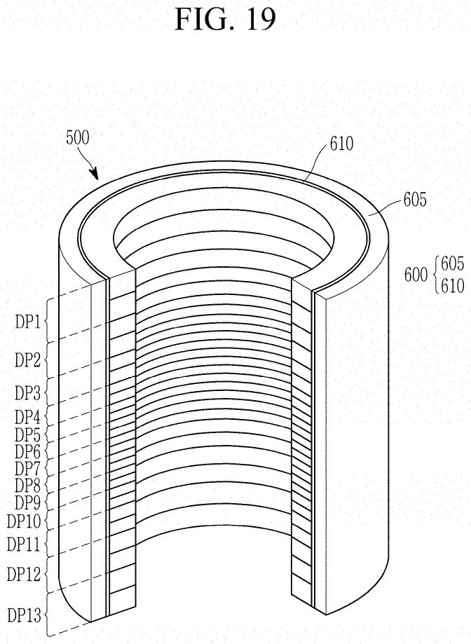

FIG. 19 is a diagram illustrating a superconducting coil module according to an exemplary embodiment.

FIG. 19 is a diagram of cutting a partial region in order to specifically show an inside of a superconducting coil module and coupling between superconducting coils and a magnetic dam. In FIG. 19, a cutting diagram in which a partial region corresponding to ¼ of an entire region is cut is illustrated.

As illustrated in FIG. 19, a superconducting coil module 500 includes a plurality of double pancake superconducting coils DP1 to DP13. Two superconducting coils DP1 and DP13 have the same specification, two superconducting coils DP2 and DP12 have the same specification, two superconducting coils DP3 and DP11 have the same specification, two superconducting coils DP4 and DP10 have the same specification, and five superconducting coils DP5 to DP9 have the same specification. Each of the plurality of superconducting coils DP1 to DP13 as a double pancake type has a structure in which two superconducting coils are stacked. his is an example for describing the present invention, and the present invention is not limited thereto.

Specific specifications for the plurality of superconducting coils illustrated in FIG. 19 are organized in Table 1.

TABLE 1

| Parameters | | C1 | C2 | C3 | C4 | C5 |
|---|---|---|---|---|---|---|
| Average width | [mm] | 4.1 | 5.1 | 6.1 | 7.1 | 8.1 |
| Inner diameter | [mm] | 78.0 | | | | |
| Outer diameter | [mm] | 101.8 | | | | |
| Number of DP | [mm] | 5 × 1 | 1 × 2 | 1 × 2 | 1 × 2 | 1 × 2 |

| | | |
|---|---|---|
| Turn per pancake | | 140 |
| Inductance | [H] | 0.521 |
| Stored energy @343 | A[kJ] | 25.4 |

In Table 1, C1 indicates five superconducting coils DP5 to DP9, C5 indicates two superconducting coils DP1 and DP13, C4 indicates two superconducting coils DP2 and DP12, C3 indicates two superconducting coils DP3 and DP11, and C2 indicates two superconducting coils DP4 and DP10. A case where “Number of DP” of C1 is disclosed as “5×1” means that there is one type in which five superconducting coils DP5 to DP9 are stacked. The remaining “1×2” means that there are two superconducting coils having the corresponding specification. As seen in Table 1, five types of superconducting coils are different in terms of average width, but the same as each other in terms of the remaining specifications. The superconducting coil module 500 stores energy of 25.4 [kJ] when the current of 342 A flows, and total inductance is 0.521 [H].

The magnetic dam 600 of FIG. 19 is implemented as the no-insulation type. The magnetic dam 600 includes a conductive structure device 605 and an insulation device 610. The insulation device 610 is located between the plurality of superconducting coils DP1 to DP13 and the conductive structure device 605, and the conductive structure device 605 is electromagnetically coupled to the plurality of superconducting coils DP1 to DP13. The magnetic dam 600 is illustrated as the no-insulation type in FIG. 19, but the insulation type magnetic dam may also be coupled to the plurality of superconducting coils DP1 to DP13 in the same scheme. The conductive structure device 605 is implemented by winding a conductive wire having a width of 0.8 mm and a thickness of 4 mm.

In order to show an effect according to an exemplary embodiment, a quench simulation is performed while changing a thickness of the magnetic dam 600. Specifically, as disclosed in Table 2, a winding inner radius of the magnetic dam 600 is fixed to 51.2 mm, and a winding outer radius is changed to 53.2 mm, 54.2 mm, 55.2 mm, 56.2 mm, and 57.2 mm. A radial build (winding outer radius—winding inner radius) which is the thickness of the magnetic dam 600 is changed to 2 mm, 3 mm, 4 mm, 5 mm, and 6 mm. In this case, a thickness of the insulation device 610 is constant, and a thickness of the conductive structure device 605 is changed.

TABLE 2

| Parameters | | Values | | | | |
|---|---|---|---|---|---|---|
| Wire material | | Copper, RRR 100 | | | | |
| Wire width; thickness | [mm] | 0.8; 4 | | | | |
| Winding inner radius | [mm] | 51.2 | | | | |
| Winding outer radius | [mm] | 53.2 | 54.2 | 55.2 | 56.2 | 57.2 |
| *Radial build | [mm] | 2 | 3 | 4 | 5 | 6 |
| Height | [mm] | 160 | | | | |
| Dissipated energy | [kJ] | 6.67 | 8.54 | 10.3 | 10.7 | 11.4 |
| **Jₚₑₐₖ | [A/mm²] | 1440 | 1120 | 901 | 700 | 577 |
| Coupling coefficient | | 0.878 | 0.871 | 0.864 | 0.858 | 0.851 |

**Jpeak: Peak current density of magnetic dam during a quench

As disclosed in Table 2, when the quench occurs in the simulation, energy consumed in the magnetic dam 600 is the largest if the thickness of the magnetic dam 600 is 6 mm. As the thickness of the magnetic dam 600 increases, a magnetic coupling coefficient between the plurality of superconducting coils and the magnetic dam decreases in the superconducting coil module, so the thickness of the magnetic dam 600 should be designed so that the coupling coefficient is not equal to or less than a predetermined threshold. The coupling coefficient of the magnetic dam in the superconducting coil module should be secured as a value which is large as possible. That is, the thickness of the magnetic dam 600 should be determined by considering both the energy consumed when the quench occurs, and the coupling coefficient.

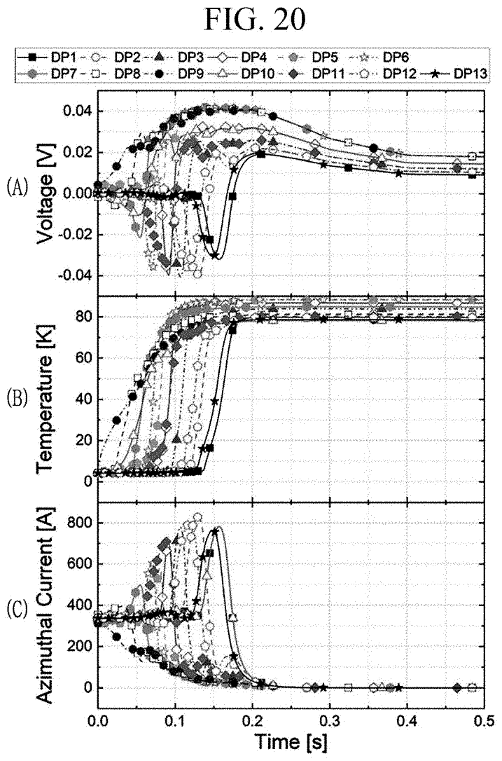

FIG. 20 is a graph showing a simulation result for a voltage, a temperature, and a current of each of a plurality of superconducting coils when a quench occurs in a condition that there is no magnetic dam in the superconducting coil module of FIG. 19.

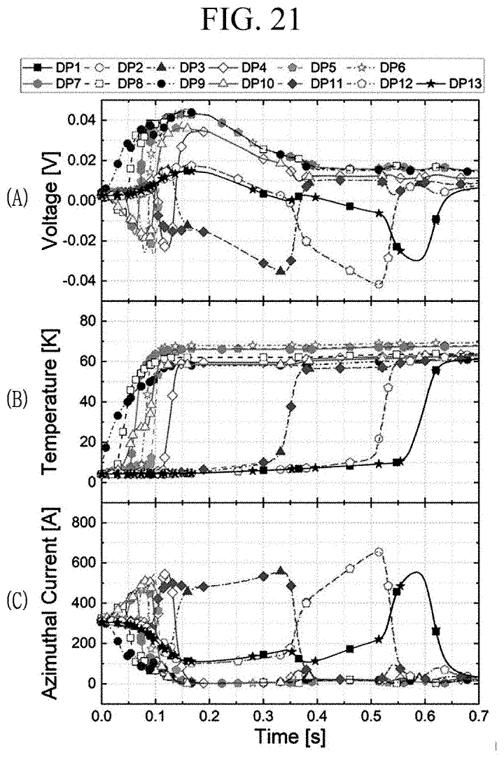

FIG. 21 is a graph showing a simulation result for a voltage, a temperature, and a current of each of a plurality of superconducting coils when the quench occurs in the superconducting coil module of FIG. 19.

When the quench occurs in a lumped parameter circuit model for the superconducting coil module, a voltage, a temperature, and a current of each of the plurality of superconducting coil modules DP1 to DP13 are simulated through COMSOL multiphysics.

Referring to a quench simulation result for the superconducting coil module in a condition without the magnetic dam illustrated in FIG. 20, the quench first occurs in the superconducting coil DP9 among the plurality of superconducting coils DP1 to DP13, and then propagated in both directions, and as a result, the quench is propagated up to the superconducting coil DP1 within approximately 0.2 seconds. The peak temperature by the quench is approximately 80 K and the peak current by the quench is approximately 800 A.

Referring to a quench simulation result for the superconducting coil module including the magnetic dam illustrated in FIG. 21, approximately 0.7 seconds are consumed until the quench first occurs in the superconducting coil DP9 among the plurality of superconducting coils DP1 to DP13, and then propagated in both directions, and propagated up to the superconducting coil DP1. This shows that a propagation speed of the quench is remarkably improved as compared with the case without the magnetic dam. Further, the peak temperature by the quench is approximately 70 K and the peak current by the quench is approximately 600 A. This also shows that a temperature raise width and a current rise magnitude by the quench decrease as compared with the case without the magnetic dam.

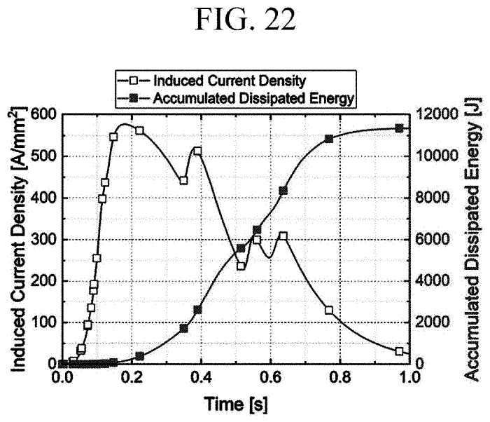

FIG. 22 is a graph showing an accumulation amount of an inducted current density and consumed energy of the magnetic dam when the quench occurs in the superconducting coil module of FIG. 19.

As illustrated in FIG. 22, a peak current density is 577 [^{A/mm}^{²}] and a total dissipated energy is 11.4 [kJ]. When an energy stored in the superconducting coil module 500 is 25.4 [kJ], an energy of approximately 45% is dissipated by the magnetic dam.

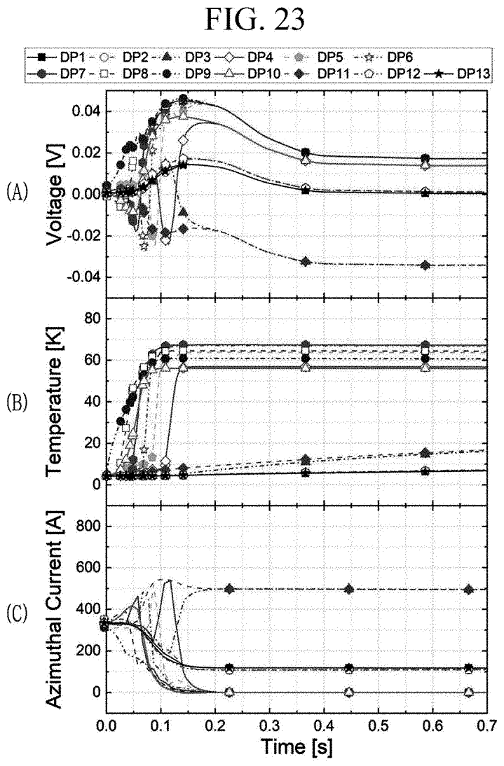

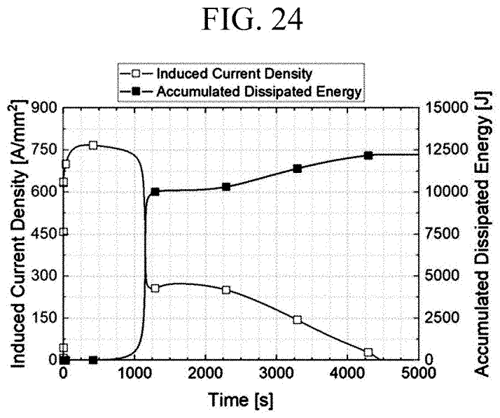

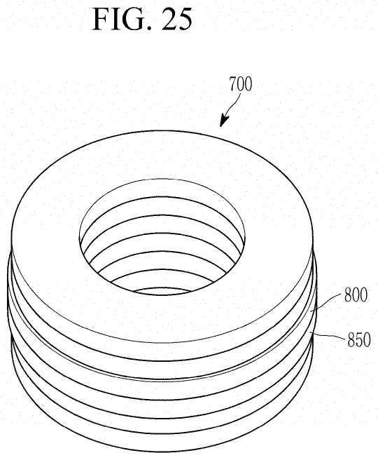

In an exemplary embodiment illustrated in FIG. 19, the conductive structure device of the magnetic dam is manufactured by copper (RRR 100). When the material of the conductive structure device of the magnetic dam is High Temperature Superconductor (HTS) instead of the copper, the influence by the quench is smaller than the influence when the material is the copper. A simulation result when all conditions are the same except for a case where the material of the conductive structure device of the magnetic dam is changed from the copper to the high temperature superconductor in the superconducting coil module illustrated in FIG. 19 above is shown in FIGS. 23 and 24.

FIG. 23 is a graph showing a simulation result for a voltage, a temperature, and a current of each of a plurality of superconducting coils when the quench occurs in the superconducting coil module of FIG. 19, which includes a magnetic dam manufactured by a high temperature superconductor.

A simulation result of FIG. 23 is a result acquired by assuming that the quench first occurs in the superconducting coil DP9 among the plurality of superconducting coils DP1 to DP13.

As illustrated in FIG. 23A, there is no voltage change by the quench in the superconducting coils DP1, DP2, DP12, and DP13. That is, it can be seen that a magnetic dam made of HTS shows a significantly large magnetic flux compensation effect.

As illustrated in FIG. 23B, it can be seen that in the superconducting coils DP1, DP2, DP3, DP11, DP12, and DP13, a quench propagation speed decreases by the magnetic dam, and as a result, a temperature rise is slow or not almost occurs.

As illustrated in FIG. 23C, the current is not almost induced in the superconducting coils DP1, DP2, DP12, and DP13. It can be seen that a peak value of the induced current in the superconducting coils DP3 and DP11 is even lower than that in the simulation result of FIG. 21 (650 [A]→550 [A]).

FIG. 24 is a graph showing an accumulation amount of an inducted current density and consumed energy of the magnetic dam when the quench occurs in magnetic dam manufactured by a high temperature superconductor. As illustrated in FIG. 24, a peak current density is 767 [^{A/mm}^{²}] and a total dissipated energy is 12.2 [kJ]. When an energy stored in the superconducting coil module 500 is 25.4 [kJ], an energy of approximately 48% is dissipated by the magnetic dam. It can be seen that the current induced to the magnetic dam manufactured by the high temperature superconductor is larger than that in the simulation result of FIG. 20. That is, the larger current is induced to the magnetic dam to compensate a magnetic flux, thereby preventing the quench from being propagated to another superconducting coil adjacent to the superconducting coil in which the quench occurs.

In an exemplary embodiment illustrated in FIG. 19, the magnetic dam is coupled to the entirety of exteriors of the plurality of superconducting coils. However, the present invention is not limited thereto, and the magnetic dam may be coupled only a partial region in all of the plurality of superconducting coils.

FIG. 25 is a perspective view of a superconducting coil module according to an exemplary embodiment.

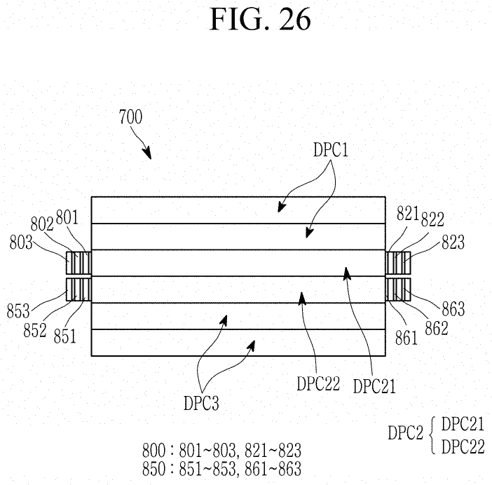

FIG. 26 is a diagram schematically illustrating a cross section of the superconducting coil module illustrated in FIG. 25.

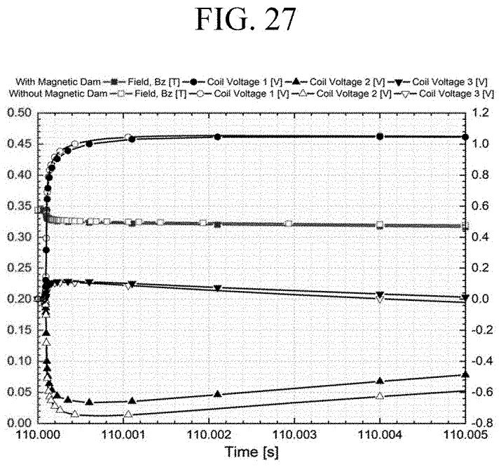

FIG. 27 is a graph showing a quench simulation result for the superconducting coil module according to an exemplary embodiment of FIG. 25. As illustrated in FIGS. 25 and 26, a superconducting coil module 700 includes a plurality of superconducting coils DPC1 to DPC3 and two magnetic dams 800 and 850

Each of the plurality of superconducting coils DPC1 to DPC3 is implemented as the double pancake type.

The magnetic dam 800 is wound on an exterior of one pancake coil DPC21 constituting the superconducting coil DPC2 and electromagnetically coupled, and the magnetic dam 850 is wound on an exterior of the other pancake coil DPC22 in the superconducting coil DPC2 and electromagnetically coupled.

The magnetic dam 800 may be implemented by winding both the conductive wire and the insulation wire on the exterior of the pancake coil DPC21. When the conductive wire and the insulation wire are separated in units of one turn, the conductive structure device of the magnetic dam 800 includes a plurality of conductive members 801 to 803, and the insulation device of the magnetic dam 800 includes a plurality of insulation members 821 to 823. In a cross section illustrated in FIG. 26, an insulation member 821, a conductive member 801, an insulation member 822, a conductive member 802, an insulation member 823, and a conductive member 803 are wound on the pancake coil DPC21 in order.

The magnetic dam 850 may be implemented by winding both the conductive wire and the insulation wire on the exterior of the pancake coil DPC22. When the conductive wire and the insulation wire are separated in units of one turn, the conductive structure device of the magnetic dam 850 includes a plurality of conductive members 851 to 853, and the insulation device of the magnetic dam 850 includes a plurality of insulation members 861 to 863. In a cross section illustrated in FIG. 26, an insulation member 861, a conductive member 851, an insulation member 862, a conductive member 852, an insulation member 863, and a conductive member 853 are wound on the pancake coil DPC21 in order.

A case where the number of winding times is illustrated as 3 in FIG. 26 is an example for schematically illustrating the magnetic dam, and the actual number of winding times may be equal to or more than 3.

Moreover, in FIG. 26, it is illustrated that two magnetic dams 800 and 850 are coupled to the superconducting coil DPC2, but the present invention is not limited thereto. For example, the magnetic dam 800 may be coupled to the superconducting coil DPC1, and the magnetic dam 850 may be coupled to the superconducting coil DPC3. Further, the number of magnetic dams may also be 2 or more, or one.

FIG. 27 is a graph showing a voltage and a magnetic flux density of each superconducting coil when the quench occurs at a time of 110 seconds in the superconducting coil DPC1.

In FIG. 27, Coil Voltage1 means a voltage of the superconducting coil DPC1, Coil Voltage2 means a voltage of the superconducting coil DPC2, and Coil Voltage3 means a voltage of the superconducting coil DPC3, and for a comparison, a graph for a comparative example without the magnetic dams 800 and 850 is together shown.

As illustrated in FIG. 27, a peak voltage of the superconducting coil DPC2 decreases by approximately 10% (−0.76 V->−0.68 V) by the quench which occurs in the superconducting coil DPC1. Moreover, it can be seen that a time when the voltage of each superconducting coil is rapidly changed is delayed. That is, it can be seen that the quench propagation speed is delayed by the magnetic dam. As such, by the magnetic dam, the peak voltage may decrease and the quench propagation speed may be delayed.

In the drawings, the shapes of the superconducting coil and the superconducting coil support body, the shape of the conductive structure device, the shape of the insulation device, the number of winding times of the conductive wire, the number of winding times of the insulation wire, etc., are examples for describing the present invention. The examples disclosed in this specification do not limit the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

1, 100, 101, 200, 300, 400, 500, 700: Superconducting coil module
10, 20, 30, 50, 60, 70, 80, 90, 95: Magnetic dam

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A superconducting coil module comprising:
a superconducting coil configured by winding a superconducting wire a plurality of times; and
a magnetic dam wound along a shape of the superconducting coil, and electromagnetically coupled,
wherein the magnetic dam includes
a conductive structure device insulated from the superconducting coil, and implemented by a conductive wire wound along the shape of the superconducting coil a plurality of times, and
a control circuit controlling current which flows to the magnetic dam during charging and discharging of the superconducting coil between both terminals of the conductive wire.

2. The superconducting coil module of claim 1, wherein:
the conductive wire is wound along an exterior of the superconducting coil a plurality of times.

3. The superconducting coil module of claim 2, wherein:
the magnetic dam further includes
an insulation device including an insulation member located between the conductive structure device and the superconducting coil.

4. The superconducting coil module of claim 1, further comprising:
a superconducting coil support body located on an interior of the superconducting coil,
wherein the conductive wire is wound along an interior of the superconducting coil support body a plurality of times.

5. The superconducting coil module of claim 1, wherein:
the magnetic dam further includes
an insulation device including an insulation wire located between the conductive wires.

6. The superconducting coil module of claim 5, wherein:
when the conductive wire is wound along an exterior of the superconducting coil a plurality of times,
the insulation wire includes an insulation member located between the superconducting coil and the conductive wire.

7. The superconducting coil module of claim 1, wherein:
the control circuit includes,
a switching element which is in an off state when the superconducting coil is charged and discharged and in an on state when the superconducting coil is not charged and discharged.

8. The superconducting coil module of claim 1, wherein:
the control circuit includes
a diode connected between both terminals of the conductive wire so that a direction of current induced to the magnetic dam becomes an inverse direction when the superconducting coil is charged.

9. The superconducting coil module of claim 1, wherein:
the control circuit includes
a capacitor which causes resonance with an inductor component of the magnetic dam with respect to a specific frequency of an electromagnetic wave induced to the magnetic dam when a quench occurs.

10. The superconducting coil module of claim 1, wherein:
the conductive wire of the conductive structure device is a high temperature superconductor.

11. A superconducting coil module comprising:
a superconducting coil configured by winding a superconducting wire a plurality of times;
a conductive structure device including a conductive wire wound on the super conductor coil along an exterior of the superconducting coil a plurality of times;
an insulation device including a first insulation member located between the conductive structure device and the superconducting coil; and
a control circuit controlling current which flows to the magnetic dam during charging and discharging of the superconducting coil between both terminals of the conductive wire.

12. The superconducting coil module of claim 11, wherein:
the insulation device further includes
an insulation wire wound on the superconducting coil together with the conductive wire.

13. The superconducting coil module of claim 12, wherein:
when the conductive wire is separated in units of one turn in the conductive structure device, the conductive structure device includes a plurality of conductive members,
when the insulation wire is separated in units of one turn in the insulation device, the insulation device includes a plurality of second insulation members, and
one corresponding second insulation member among of the plurality of second insulation members is located between two adjacent conductive members among the plurality of conductive members.

14. The superconducting coil module of claim 11, wherein:
the conductive wire of the conductive structure device is a high temperature superconductor.

15. A superconducting coil module comprising:
a superconducting coil configured by winding a superconducting wire a plurality of times;
a superconducting coil support body located on an interior of the superconducting coil;
a conductive structure device including a conductive wire wound on the superconducting coil along an interior of the superconducting coil support body a plurality of times; and
a control circuit controlling current which flows to the magnetic dam during charging and discharging of the superconducting coil between both terminals of the conductive wire.

16. The superconducting coil module of claim 15, further comprising:
an insulation device including an insulation wire wound on the superconducting coil together with the conductive wire.

17. The superconducting coil module of claim 16, wherein:
when the conductive wire is separated in units of one turn in the conductive structure device, the conductive structure device includes a plurality of conductive members,
when the insulation wire is separated in units of one turn in the insulation device, the insulation device includes a plurality of insulation members, and
one corresponding insulation member among of the plurality of insulation members is located between two adjacent conductive members among the plurality of conductive members.

18. A superconducting coil module comprising:
a plurality of superconducting coil configured by winding a superconducting wire a plurality of times; and
a magnetic dam electromagnetically coupled to at least one of the plurality of superconducting coils,
wherein the magnetic dam includes
a conductive structure device insulated from the superconducting coil, and implemented by a conductive wire wound in a pattern based on a shape of the superconducting coil a plurality of times,
the at least one superconducting coil includes two adjacent superconducting coils, and
the magnetic dam is located between the two adjacent superconducting coils.

19. The superconducting coil module of claim 18, wherein:
the magnetic dam further includes
a control circuit controlling current which flows to the magnetic dam during charging and discharging of the superconducting coil between both terminals of the conductive wire.

20. The superconducting coil module of claim 19, wherein:
the conductive structure device includes
a conductive wire wound along shapes of the two adjacent superconducting coils between the two adjacent superconducting coils, and
the magnetic dam further includes
an insulation device including an insulation wire wound along the shape of the superconducting coil together with the conductive wire.
